(19) United States
(12) Patent Application Publication
(10) Pub. No.: US 2026/0125045 A1
(43) Pub. Date: May 7, 2026

(54) HYBRID VEHICLE

(71) Applicant: TOYOTA JIDOSHA KABUSHIKI KAISHA, Toyota-shi (JP)

(72) Inventor: Makoto YOSHIOKA, Toyota-shi (JP)

(73) Assignee: TOYOTA JIDOSHA KABUSHIKI KAISHA, Toyota-shi (JP)

(21) Appl. No.: 19/321,451

(22) Filed: Sep. 8, 2025

(30) Foreign Application Priority Data
Nov. 7, 2024 (JP) 2024-195423

(51) Int. Cl. B60W 20/15; B60W 10/02; B60W 10/08; B60W 10/10

(52) U.S. Cl. CPC B60W 20/15; B60W 10/02; B60W 10/08; B60W 10/10

(57) ABSTRACT

A hybrid vehicle includes an engine, a fan that rotates in conjunction with the engine, a first motor connected to the engine and provided on a power transmission path between the engine and a driving wheel, a second motor provided on the power transmission path, a torque converter provided on the power transmission path between the first motor and the second motor, a first power control unit configured to control electric power to the first motor, a second power control unit configured to control electric power to the second motor, a motor radiator that is cooled by the fan and promotes heat dissipation of cooling water circulating through the first and second motors and the first and second power control units, and a vehicle control unit.

### CROSS-REFERENCE TO RELATED APPLICATION

This application is based upon and claims the benefit of priority of the prior Japanese Patent Application No. 2024-195423, filed on November 7, 2024, the entire contents of which are incorporated herein by reference.

### TECHNICAL FIELD

The present disclosure relates to a hybrid vehicle.

### BACKGROUND

A hybrid vehicle is known. The hybrid vehicle is equipped with an engine, a fan that rotates in conjunction with the engine, a motor, a power control unit that controls electric power to the motor, and an engine radiator that is cooled by the fan (for example, see Japanese Unexamined Patent Application Publication No. 2016-112933).

In order to ensure the cooling performance of the motor and the power control unit, a motor radiator may be provided in addition to the engine radiator. In this case, in the motor traveling mode in which the engine is stopped and the vehicle travels by the motor, the fan is also stopped. Therefore, the motor radiator might not be sufficiently cooled, and the motor and the power control unit might not be sufficiently cooled. In the motor traveling mode, a decrease in the power of the motor might cause a decrease in the traveling performance.

### SUMMARY

It is therefore an object of the present disclosure to provide a hybrid vehicle that ensures cooling performance of motors and power control units while ensuring traveling performance in a motor traveling mode.

The above object is achieved by a hybrid vehicle including: an engine; a fan that rotates in conjunction with the engine; a first motor connected to the engine and provided on a power transmission path between the engine and a driving wheel; a second motor provided on the power transmission path; a torque converter provided on the power transmission path between the first motor and the second motor; a first power control unit configured to control electric power to the first motor; a second power control unit configured to control electric power to the second motor; a motor radiator that is cooled by the fan and promotes heat dissipation of cooling water circulating through the first and second motors and the first and second power control units; and a vehicle control unit configured to control the second power control unit to cause the hybrid vehicle to travel by the second motor and to control the first power control unit to cause the first motor to rotate the fan via the engine in a motor traveling mode in which combustion in the engine is stopped.

The vehicle control unit may be configured to control the second power control unit to cause the hybrid vehicle to travel by the second motor, when a travel request is made in the motor traveling mode and a required driving force of the hybrid vehicle is equal to or less than a threshold value, and the vehicle control unit may be configured to control the first and second power control units to cause the hybrid vehicle to travel by the first and second motors, when the travel request is made in the motor traveling mode and the required driving force is larger than the threshold value.

The hybrid vehicle may further include: an automatic transmission provided on the power transmission path between the torque converter and the second motor; and a first clutch provided in the automatic transmission, wherein the vehicle control unit may be configured to cause the first clutch to engage when the hybrid vehicle travels in the motor traveling mode, and the vehicle control unit may be configured to cause the first clutch to disengage, to control the second power control unit to stop the second motor, and to control the first power control unit to rotate the fan by the first motor via the engine, when the hybrid vehicle is stopped in the motor traveling mode.

The hybrid vehicle may further include a second clutch provided on the power transmission path between the engine and the first motor, wherein the vehicle control unit may be configured to cause the second clutch to engage in the motor traveling mode.

### BRIEF DESCRIPTION OF THE DRAWINGS

FIG. 1 is a schematic configuration view of a hybrid vehicle;

FIG. 2 is a schematic configuration view of a cooling system; and

FIG. 3 is a flowchart illustrating motor traveling control.

### DETAILED DESCRIPTION

### Schematic Configuration of Hybrid Vehicle

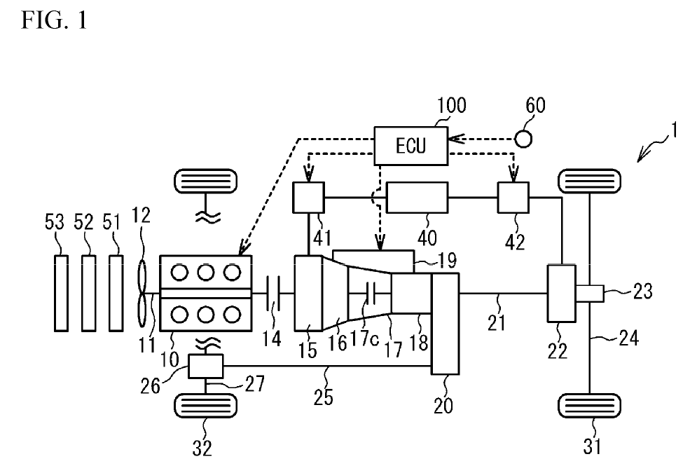

FIG. 1 is a schematic configuration view of a hybrid vehicle 1. The hybrid vehicle 1 is equipped with an engine 10, a first motor 15, and a second motor 22 as power sources for traveling. The engine 10 is a gasoline engine having a plurality of cylinders, but may be a diesel engine or a hydrogen engine. The engine 10 is disposed on the front side of the hybrid vehicle 1. The hybrid vehicle 1 includes rear wheels 31 and front wheels 32. On a power transmission path from the engine 10 to the rear wheels 31, a K0 clutch 14, the first motor 15, a torque convertor 16, an automatic transmission 17, a sub-transmission 18, a transfer 20, a rear propeller shaft 21, the second motor 22, a rear deferential 23, and a rear drive shaft 24 are provided in this order from the engine 10 to the rear wheels 31. The K0 clutch 14, the first motor 15, the torque convertor 16, the automatic transmission 17, the sub-transmission 18, the transfer 20, a front propeller shaft 25, a front differential 26, and a front drive shaft 27 are provided in this order from the engine 10 to the front wheels 32 on a power transmission path from the engine 10 to the front wheels 32.

The K0 clutch 14 is provided on the power transmission path between the engine 10 and the first motor 15. The K0 clutch 14 is brought into an engaged state by receiving the oil pressure, and connects the power transmission between the engine 10 and the first motor 15. The K0 clutch 14 is brought into a disengaged state in response to the stop of the oil pressure supply, and interrupts the power transmission between the engine 10 and the first motor 15. The K0 clutch 14 is an example of a second clutch.

The first motor 15 is connected to a battery 40 via a first power control unit (PCU) 41. The second motor 22 is connected to the battery 40 via a second PCU 42. The battery 40 is a chargeable and dischargeable secondary battery such as a nickel-hydrogen battery or a lithium-ion battery. The first motor 15 generates a driving force of the hybrid vehicle 1 in accordance with electric power supplied from the battery 40 via the first PCU 41. The second motor 22 generates a driving force of the hybrid vehicle 1 in accordance with electric power supplied from the battery 40 via the second PCU 42. The first motor 15 and the second motor 22 generate electric power for charging the battery 40 in response to power transmitted from the engine 10, the rear wheels 31, and the front wheels 32. The electric power transmitted and received between the first motor 15 and the battery 40 is adjusted by the first PCU 41. The electric power transmitted and received between the second motor 22 and the battery 40 is adjusted by the second PCU 42. The first PCU 41 is an example of a first power control unit. The second PCU 42 is an example of a second power control unit.

The torque converter 16 is a fluid coupling having a torque amplifying function. The torque converter 16 is provided on the power transmission path between the first motor 15 and the second motor 22. The torque converter 16 includes a pump impeller, a turbine runner, and a stator. The pump impeller is coupled to an output shaft of the first motor 15. The turbine runner is connected to an input shaft of the automatic transmission 17.

The automatic transmission 17 is a stepped transmission that switches the gear ratio in multiple stages. The automatic transmission 17 is provided on the power transmission path between the torque converter 16 and the second motor 22. The automatic transmission 17 includes an AT clutch 17c. The AT clutch 17c is brought into an engaged state by receiving the oil pressure, and connects the input shaft and the output shaft of the automatic transmission 17. The AT clutch 17c is brought into a disengaged state in response to the stop of the oil pressure supply. When the AT clutch 17c is in the disengaged state, the automatic transmission 17 is brought into a neutral state. The AT clutch 17c is an example of a first clutch.

The sub-transmission 18 selectively sets, for example, a gear stage having a large speed ratio between the output shaft of the automatic transmission 17 and the rear wheels 31 or a gear stage having a small speed ratio.

The K0 clutch 14, the torque convertor 16, the automatic transmission 17, and the sub-transmission 18 are supplied with oil pressure from hydraulic pumps (not illustrated) via a hydraulic control mechanism 19. The hydraulic control mechanism 19 is provided with hydraulic circuits for the K0 clutch 14, the torque convertor 16, the automatic transmission 17, and the sub-transmission 18, and various hydraulic control valves for controlling the hydraulic pressures of these hydraulic circuits.

The transfer 20 distributes the power of the engine 10, the first motor 15, and the second motor 22 to the rear wheels 31 and the front wheels 32. That is, the rear wheels 31 and the front wheels 32 are driving wheels.

A fan 12 is provided on a crankshaft 11 of the engine 10. The fan 12 rotates in conjunction with the crankshaft 11 of the engine 10. An engine radiator 51, a motor radiator 52, and an AC condenser 53 are arranged to face the fan 12. The rotation of the fan 12 cools the engine radiator 51, the motor radiator 52, and the AC condenser 53. The engine radiator 51 promotes heat radiation of the cooling water circulating in the engine 10. The motor radiator 52 promotes heat dissipation of the cooling water circulating through the first motor 15, the second motor 22, the first PCU 41, and the second PCU 42, as described in detail later. The AC condenser 53 promotes heat radiation of the refrigerant for air conditioning.

The hybrid vehicle 1 is provided with an electronic control unit (ECU) 100 as a vehicle control unit. The ECU 100 includes a processing circuit that performs various processing related to the traveling control of the vehicle. The ECU 100 is an example of a vehicle control unit.

A sensor group 60 is connected to the ECU 100. The sensor group 60 includes, for example, an ignition switch, a crank angle sensor, an air flow meter, a first motor rotation speed sensor, a second motor rotation speed sensor, an accelerator opening sensor, a shift position sensor, a vehicle speed sensor, a state of charge (SOC) sensor, and a traveling mode changeover switch. The ignition switch detects whether the ignition is turned on or off. The crank angle sensor detects the number of rotations of the crankshaft 11 of the engine 10. The air flow meter detects the amount of intake air introduced into the engine 10. The first motor rotational speed sensor detects the rotational speed of the first motor 15. The second motor rotational speed sensor detects the rotational speed of the second motor 22. The accelerator opening sensor detects an accelerator opening that is an opening of an accelerator pedal operated by a driver. The shift position sensor detects whether the shift lever is in P-range, R-range, N-range, or D-range position. The vehicle speed sensor detects the traveling speed of the hybrid vehicle 1. The SOC sensor detects the charge amount of the battery 40. The traveling mode changeover switch is a switch capable of switching a traveling mode to be described later.

The ECU 100 controls the driving of the engine 10, the first motor 15, and the second motor 22. In particular, the ECU 100 controls the first PCU 41 to adjust the electric power supplied from the battery 40 to the first motor 15. Thus, the ECU 100 controls the power of the first motor 15. The ECU 100 controls the second PCU 42 to adjust the electric power supplied from the battery 40 to the second motor 22. Thus, the ECU 100 controls the power of the second motor 22. The ECU 100 controls the K0 clutch 14, the automatic transmission 17, and the sub-transmission 18 through the control of the hydraulic control mechanism 19.

The ECU 100 causes the hybrid vehicle 1 to travel in either the motor traveling mode or the hybrid traveling mode. In the motor traveling mode, as will be described in detail later, combustion in the engine 10 is stopped, and the K0 clutch 14 is engaged to rotate the rear wheels 31 and the front wheels 32 by the power of at least one of the first motor 15 and the second motor 22. In the hybrid traveling mode, the K0 clutch 14 is engaged to rotate the rear wheels 31 and the front wheels 32 by at least the power of the engine 10. For example, when the required driving force for the hybrid vehicle 1 is equal to or greater than a predetermined value, the motor traveling mode is switched to the hybrid traveling mode. When the charge amount of the battery 40 is equal to or less than a predetermined value, the traveling mode is switched from the motor traveling mode to the hybrid traveling mode. The traveling mode is switched by the traveling mode changeover switch.

### Schematic Configuration of Cooling System

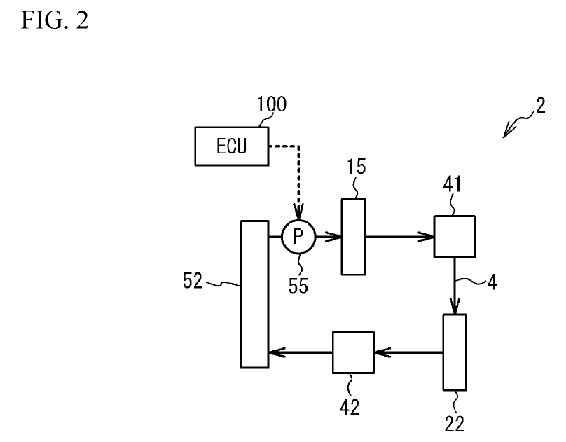

FIG. 2 is a schematic configuration view of a cooling system 2. The cooling system 2 is mounted on the hybrid vehicle 1. The motor radiator 52, a water pump 55, the first motor 15, the first PCU 41, the second motor 22, and the second PCU 42 are disposed on a path 4 through which the cooling water flows. The water pump 55 is electrically driven and controlled by the ECU 100. The water pump 55 is driven to circulate the cooling water through the motor radiator 52, the first motor 15, the first PCU 41, the second motor 22, and the second PCU 42 via the path 4. Thus, the first motor 15, the first PCU 41, the second motor 22, and the second PCU 42 are cooled. The order of the flow of the cooling water is not limited to this. The first motor 15, the second motor 22, the first PCU 41, and the second PCU 42 may be connected in parallel or in series.

### Motor Traveling Control

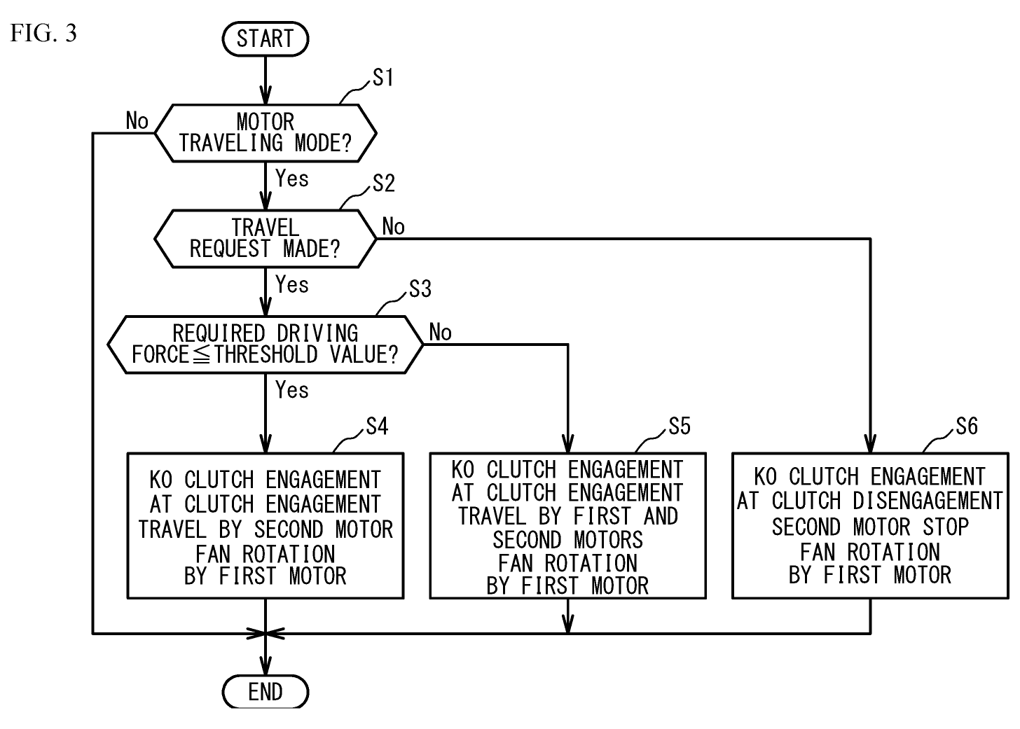

FIG. 3 is a flowchart illustrating an example of motor traveling control. This control is repeatedly executed while the ignition is on. The ECU 100 determines whether the traveling mode is the motor traveling mode (step S1). This determination is made based on, for example, the required driving force of the hybrid vehicle 1, the charge amount of the battery 40, and the state of the traveling mode changeover switch. If the determination result is No in step S1, the control is terminated.

If the determination result is Yes in step S1, the ECU 100 determines whether or not a travel request is made (step S2). This determination is made based on, for example, the position of the shift lever, the accelerator opening, and the vehicle speed. For example, when the shift lever is in the D-range position or the R-range position and the accelerator opening degree indicates that the accelerator pedal is depressed, the determination result in step S2 is Yes. When the shift lever is in the N-range position or the P-range position, the determination in step S2 is No.

If the determination result in step S2 is Yes, the ECU 100 determines whether the required driving force for the hybrid vehicle 1 is equal to or less than a threshold value (step S3). The threshold value is set to an upper limit value at which both the rear wheels 31 and the front wheels 32 are capable of being driven by the power of only the second motor 22. The required driving force is determined based on the accelerator opening. When the accelerator opening is equal to or less than a predetermined value, the determination result is Yes in step S3. When the accelerator opening is larger than the predetermined value, the determination result is No in step S3.

If the determination result in step S3 is Yes, the ECU 100 causes the K0 clutch 14 and the AT clutch 17c to engage, causes the hybrid vehicle 1 to travel by the second motor 22, and causes the fan 12 to rotate by the first motor 15 via the engine 10 (step S4). In particular, the ECU 100 controls the second PCU 42 to supply the second motor 22 with sufficient electric power to drive both the rear wheels 31 and the front wheels 32 by the second motor 22. A part of the power of the second motor 22 is transmitted to the rear wheels 31 via the rear differential 23 and the rear drive shaft 24, and the remaining part of the power of the second motor 22 is transmitted to the front wheels 32 via the rear propeller shaft 21, the transfer 20, the front propeller shaft 25, the front differential 26, and the front drive shaft 27. The ECU 100 controls the first PCU 41 to supply the first motor 15 with sufficient electric power to rotate the fan 12 via the crankshaft 11. In this case, the first motor 15 is not supplied with electric power required to drive the rear wheels 31 and the front wheels 32.

If the determination result in step S3 is No, the ECU 100 causes the K0 clutch 14 and the AT clutch 17c to engage, causes the hybrid vehicle 1 to travel by the first motor 15 and the second motor 22, and causes the first motor 15 to rotate the fan 12 (step S5). In particular, the ECU 100 controls the second PCU 42 to supply the second motor 22 with sufficient electric power to drive both the rear wheels 31 and the front wheels 32 by the second motor 22. Further, the ECU 100 controls the first PCU 41 to supply the first motor 15 with electric power sufficient to rotate the fan 12 via the crankshaft 11 by the first motor 15 and to drive both the rear wheels 31 and the front wheels 32.

Therefore, a part of the power of the first motor 15 is transmitted to the fan 12 via the K0 clutch 14, and the remaining power of the first motor 15 is transmitted to the rear wheels 31 and the front wheels 32. Therefore, the electric power supplied to the first motor 15 in step S5 is higher than the electric power supplied to the first motor 15 in step S4. That is, the power of the first motor 15 in the step S5 is higher than the power of the first motor 15 in the step S4.

If the determination result is No in step S2, the ECU 100 causes the K0 clutch 14 to engage, causes the AT clutch 17c to disengage, and rotates the fan 12 by the first motor 15 while stopping the second motor 22 (step S6). In particular, the ECU 100 controls the second PCU 42 to stop the electric power supplied to the second motor 22. At this time, the AT clutch 17c is disengaged. For example, when the first motor 15 is driven while the second motor 22 is stopped with the AT clutch 17c engaged, the pump impeller of the torque converter 16 rotates relative to the turbine wheel that is stopped. As a result, the torque converter 16 generates heat. When the AT clutch 17c is disengaged, the pump impeller and the turbine wheel rotate in the same direction, and the heat generation of the torque convertor 16 is suppressed.

As described above, in any of the steps S4 to S6, the fan 12 is rotated by the first motor 15 via the engine 10. Thus, heat dissipation of the cooling water in the motor radiator 52 is promoted, and the cooling performances of the first motor 15, the second motor 22, the first PCU 41, and the second PCU 42 in the motor traveling mode are ensured.

Further, as in steps S4 and S5, the power of the first motor 15 and the second motor 22 required to drive the rear wheels 31 and the front wheels 32 is controlled in accordance with the required driving force. Therefore, the traveling performance in the motor traveling mode is also ensured.

In the above embodiment, the sub-transmission 18, the transfer 20, the front propeller shaft 25, and the front differential 26 are provided, but these may be omitted. That is, only the rear wheels 31 may be driving wheels, and the front wheels 32 may be driven wheels.

Although some embodiments of the present disclosure have been described in detail, the present disclosure is not limited to the specific embodiments but may be varied or changed within the scope of the present disclosure as claimed.

What is claimed is:

1. A hybrid vehicle comprising:
an engine;
a fan that rotates in conjunction with the engine;
a first motor connected to the engine and provided on a power transmission path between the engine and a driving wheel;
a second motor provided on the power transmission path;
a torque converter provided on the power transmission path between the first motor and the second motor;
a first power control unit configured to control electric power to the first motor;
a second power control unit configured to control electric power to the second motor;
a motor radiator that is cooled by the fan and promotes heat dissipation of cooling water circulating through the first and second motors and the first and second power control units; and
a vehicle control unit configured to control the second power control unit to cause the hybrid vehicle to travel by the second motor and to control the first power control unit to cause the first motor to rotate the fan via the engine in a motor traveling mode in which combustion in the engine is stopped.

2. The hybrid vehicle according to claim 1, wherein
the vehicle control unit is configured to control the second power control unit to cause the hybrid vehicle to travel by the second motor, when a travel request is made in the motor traveling mode and a required driving force of the hybrid vehicle is equal to or less than a threshold value, and
the vehicle control unit is configured to control the first and second power control units to cause the hybrid vehicle to travel by the first and second motors, when the travel request is made in the motor traveling mode and the required driving force is larger than the threshold value.

3. The hybrid vehicle according to claim 2, further comprising:
an automatic transmission provided on the power transmission path between the torque converter and the second motor; and
a first clutch provided in the automatic transmission,
wherein
the vehicle control unit is configured to cause the first clutch to engage when the hybrid vehicle travels in the motor traveling mode, and
the vehicle control unit is configured to cause the first clutch to disengage, to control the second power control unit to stop the second motor, and to control the first power control unit to rotate the fan by the first motor via the engine, when the hybrid vehicle is stopped in the motor traveling mode.

4. The hybrid vehicle according to claim 3, further comprising a second clutch provided on the power transmission path between the engine and the first motor,
wherein the vehicle control unit is configured to cause the second clutch to engage in the motor traveling mode.
